(19) United States
(12) Patent Application Publication
(10) Pub. No.: US 2009/0214300 A1
(43) Pub. Date: Aug. 27, 2009

(54) DEVICES, SYSTEMS, AND METHODS FOR MEASURING AND CONTROLLING COMPACTIVE EFFORT DELIVERED TO A SOIL BY A COMPACTION UNIT

(76) Inventors: Bjorn Birgisson, Danderyd (SE); David Bloomquist, Gainesville, FL (US); Michael McVay, Gainesville, FL (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/914,897

(22) PCT Filed: May 25, 2006
(86) PCT No.: PCT/US06/20545

§ 371 Date: Jun. 26, 2008

Related U.S. Application Data
(60) Provisional application No. 60/684,868, filed on May 25, 2005.

(51) Int. Cl. E02D 3/02; G05B 13/02

(52) U.S. Cl. 405/271; 700/275

(57) ABSTRACT

According to various embodiments, devices, systems, and methods are provided for controlling a compactive effort delivered to a soil by a compaction unit. A device, according to one embodiment, includes a compaction unit (13) that delivers a compactive effort to soil, first and second sensing units (12, 14) that measure the first and second sensing data at a discrete global position at a first and second point in time, respectively, a comparing unit that compares the first and second sensing data, and a control unit (18) that modifies the compactive effort delivered to the soil by the compaction unit based on the comparison between the first and second sensing data. The discrete global position is in front of the compaction unit in the direction of travel of the compaction unit at the first point in time and is behind the compaction unit at the second point in time.

### BACKGROUND OF THE INVENTION

1. Field of the Invention

Various embodiments of the invention relate to devices, systems, and methods for controlling the compactive effort delivered to a soil by a compaction unit and to devices, systems, and methods for continuously measuring the stiffness of a soil undergoing compaction and, more particularly, to devices, systems, and methods for controlling compactive effort by comparing real-time measurements of waveforms passing through the soil before, during, and after the compaction and comparing the difference to a reference or target stiffness and/or modulus value.

2. Background of the Related Art

Soil is a bi-product of eons of the chemical and/or the mechanical breakdown or decomposition of rock. Within a soil profile, however, the soil is spatially non-uniform, i.e., horizontally and vertically. Furthermore, besides the remains of broken or decomposed rock, soil can include one or more of water (or other liquids), air (or other gases), organic matter (e.g., leaves, twigs, etc.), and non-organic matter (e.g., litter, glass, paper, etc.).

In civil and geotechnical engineering practice, in situ soil density is believed by many to be one of the most important engineering properties of the soil. Soil density, which refers to the mass per unit volume of the soil, is a parameter that engineers frequently modify artificially (e.g., through compaction, pre-consolidation, and the like, to suit project needs. For example, on horizontal construction sites (e.g., highway construction) and on earth-filled dams, applying one or more passes of a compaction unit (e.g., a sheep's-foot roller, a rubber-tired roller, a vibratory compactor, and the like) to a lift of structural fill, a base coarse material, a sub-base material, or the like can improve the structural response (e.g., stiffness) of the soil as a engineered material.

Heretofore, geotechnical or soils engineers have relied on soil density as a predictor of in situ performance and for quality assurance purposes. During the Great Depression, during which the U.S. government funded colossal public works projects, R. R. Proctor described the relationship between soil density, moisture content, and compactive effort. Proctor's research included preparing molds of soil in the laboratory at various moisture contents to identify the maximum dry density and the optimum moisture content for a particular soil sample. As compaction equipment became heavier (e.g., to provide greater compactive effort for airfield runways, earthen dams, etc.), the U.S. Army Corps of Engineers (the “COE”) modified the Proctor test. The COE's modifications to Proctor's density test subsequently became the modified AASHTO density test.

To confirm laboratory predictions of compactive effort and as a means of controlling the quality of a contractor's work product, in situ field density testing has been developed. For example, the sand cone test and penetrometers are widely used to estimate soil density. The sand cone test requires excavating a small volume of recently-compacted soil, determining the wet and dry weight of the soil sample, and determining the volume of the soil removed. Generally, the test is performed at shallow depths (typically less than one foot) at random locations that are spatially distributed. The test is slow, destructive, time consuming, and a poor predictor of the density and suitability of soils between the test patches as well as the density and suitability of soil beneath the small volume removed. Soil or cone penetrometers, which provide soil density based on the soil's resistance to the pushing of a pointed rod or thin-walled steel tube, are no more reliable.

Field density testing also can include using nuclear density devices (or “nukes”). Nukes direct gamma particles into the soil. Some of the particles are reflected back to the surface, where a Geiger counter detects and records the amount of backscatter. Because greater backscatter results from a denser soil, nukes provide an estimate of the in situ soil density. However, although nukes are not destructive and are faster to operate than sand cones, nukes are also performed at random locations that are spatially distributed. In addition, nukes typically do not work well when the soil is wet. Furthermore, the use of nukes requires special training, certification, handling, security, and storage.

As a result, the use of soil density as a predictor and guarantor of adequate soil strength is fraught with problems, which are addressed and accounted for by adding a high factor of safety. Some engineers and scientists, however, believe that soil density is not the best indicator of soil performance. Particularly, some engineers and scientists believe that “stiffness” is a better measure of soil performance. Indeed, although mercury is about 13.6 times denser than water and about seven times denser than a typical soil, it lacks the strength to support a highway. More specifically, some engineers and scientists believe that the elastic and/or elasto-plastic displacement of soil that has been compacted is a better indicator of soil performance.

Therefore, it would be desirable to provide devices, systems, and methods for predicting the performance of the soil of a work site (e.g., a lift, a base coarse, a sub-base and the like) and that can make such predictions in real-time and continuously over the entire work site in a non-destructive and non-intrusive manner. It would be even more desirable to provide devices, systems, and methods for measuring and controlling the compactive effort delivered to the work site (e.g., a lift, a base coarse, a sub-base and the like) to improve the stiffness and/or elastic displacement of the soil.

### SUMMARY OF THE INVENTION

According to various embodiments of the invention, a soil compacting device is provided that includes: (1) a compaction unit adapted for delivering a compactive effort to a soil, (2) a first sensing unit that is adapted to measure first sensing data at a discrete global position at a first point in time, and (3) a second sensing unit that is adapted to measure second sensing data at the discrete global position at a second point in time that is later than the first point in time. In one embodiment, the compaction unit is movable in a desired direction of travel, and the discrete global position is in front of the compaction unit in the direction of travel at the first point in time and behind the compaction unit at the second point in time.

In a further embodiment, the soil compacting device also includes: (1) a comparing unit that is adapted to compare the first sensing data and the second sensing data and (2) a control unit that is adapted to modify the compactive effort delivered to the soil by the compaction unit based on the comparison between the first sensing data and the second sensing data.

In one particular embodiment, the comparing unit is adapted to determine a difference between the first and the second sensing data and compare the difference with a predetermined reference value. In another embodiment, the control unit is adapted to modify the compactive effort delivered to the soil based on the comparison of the difference between the first sensing data and the second sensing data and the predetermined reference value.

According to various embodiments of the invention, a method is provided for controlling a compactive effort delivered to a soil by a compaction unit. The method includes the steps of: (1) measuring first soil data at a plurality of discrete locations over an area; (2) providing a compactive effort to the area; (3) measuring second soil data at the plurality of discrete locations; (4) determining a difference between the first soil data and the second soil data; (5) comparing the difference with a predetermined reference value; and (6) modifying the compactive effort delivered to the soil by the compaction unit based on results from the step of comparing the difference with the predetermined reference value.

According to various other embodiments of the invention, a program embodied in a computer-readable medium is provided for controlling a compactive effort delivered to a soil by a compaction unit. The program comprises (1) computer executable instructions for measuring first soil data at a plurality of discrete locations over an area, (2) computer executable instructions for instructing a compaction unit to deliver a compactive effort to the area of the plurality of discrete locations; and (3) computer executable instructions for measuring second soil data at said plurality of discrete locations. In a particular embodiment, the program further comprises (1) computer executable instructions for determining a difference between the first soil data and the second soil data, (2) computer executable instructions for comparing the difference between the first soil data and the second soil data with a predetermined reference value, and (3) computer executable instructions for instructing the compaction unit to modify the compactive effort delivered to the soil based on results from the comparison step.

According to various embodiments of the invention, a soil stiffness testing device is provided for testing a soil under compaction to ensure the soil is compacted to a predetermined stiffness value. The device includes (1) a compaction unit adapted for delivering a compactive effort to a soil, (2) a first sensing unit adapted to measure first sensing data at a discrete global position at a first point in time, (3) a second sensing unit adapted to measure second sensing data at the discrete global position at a second point in time that is later than the first point in time, and (4) a control unit adapted to store the first sensing data and the second sensing data. The compaction unit is moveable in a desired direction of travel, and the discrete global position is in front of the compaction unit in the direction of travel at the first point in time and behind the compaction unit at the second point in time.

According to various embodiments of the invention, a method is provided for continuously testing a soil under compaction to ensure the soil is compacted to a predetermined stiffness value. The method comprises the steps of: (1) continuously measuring first soil data at a plurality of discrete locations in a discrete area, (2) providing a compactive effort to the discrete area of the plurality of discrete locations, and (3) continuously measuring second soil data at said plurality of discrete locations.

### BRIEF DESCRIPTION OF THE DRAWINGS

The invention will be better understood by reference to the following more detailed description and accompanying drawings where like reference numbers refer to like parts:

FIG. 1 illustrates a top view of a device and system for continuously monitoring compactive effort in accordance with one embodiment of the present invention;

FIG. 2 illustrates a device and system for continuously monitoring compactive effort in accordance with one embodiment of the present invention;

FIG. 3 illustrates a controlling unit in accordance with one embodiment of the present invention;

FIG. 4 is a flow chart of a method of controlling compactive effort delivered to a soil in accordance with one embodiment of the present invention;

FIG. 5 is a flow chart of another method of continuously monitoring the compactive effort delivered to a soil in accordance with another embodiment of the present invention; and

FIG. 6A illustrates dismounted positioning of sensing units in a direction perpendicular to the direction of travel of a prime mover according to one embodiment of the invention; and

FIG. 6B illustrates dismounted positioning of sensing units in-line with the direction of travel of the prime mover according to one embodiment of the invention.

### DETAILED DESCRIPTION OF THE INVENTION

Under most loading conditions in which a load is applied for a short period of time and then removed (e.g., an impact load), especially the loads associated with compactive effort, soil behaves elastically or substantially elastically. As a result, soil's reaction to such loading has been likened to that of a spring. Taking the spring analogy one step further and recalling that the energy, E, required to move (e.g., compress or stretch) a spring a distance, x, is given by the equation:

E=½·k·x²

where k is the “spring constant”, which is a measurement or an indicia of the stiffness of the spring, it stands to reason that one can predict the spring constant (e.g., the soil stiffness and/or modulus) for a known energy (e.g., a compactive effort) and a measured displacement. By comparing the predicted spring constant, k, with a predetermined, allowable reference stiffness value, k_{ref}, one can increase or decrease the energy until the spring constant falls within a tolerable margin of error with respect to the predetermined reference stiffness value, k_{ref}. Or, put another way, for a given compactive effort and for the predetermined reference stiffness value, k_{ref}, displacement of the soil spring, x, after applying compactive effort can provide an indication of the stiffness of the soil. In turn, stiffness can become a predictor of performance of the compacted soil.

Direct, continuous measurement of displacements over an entire work site (e.g., a horizontal construction site) cannot be performed practically or economically. Nevertheless, continuous, indirect measurement of displacement is possible (e.g., using Fast Fourier Transforms (“FFT”) and the like) by double integrating acceleration measurements of waveforms with respect to time. Indeed, acceleration, which is the second derivative of displacement with respect to time, of a waveform is provided mathematically by the following equation:

$$Accelaration = - ω \cdot A \cdot sin ω t = \frac{{d}^{2} x}{d {t}^{2}}$$

where A is the maximum displacement, t is the time (in seconds), and ω is the frequency (in radians per second). Taking the first integral of acceleration with respect to time provides the velocity, and by further integrating velocity with respect to time, one gets displacement, which is expressed mathematically by the following equation:

Displacement (x)=A·sin ωt

Accordingly, given a predetermined, reference soil stiffness value, k_{ref}, for a given compactive effort, the acceleration of vibration-induced waveforms in the soil before and after the compactive effort and other waveform data can be measured continuously. Using these before and after acceleration measurements, displacement due to the compactive effort can be estimated. The relationship or change in displacement before and after compaction can be compared to a target value for the predetermined, or target, soil stiffness value, k_{ref}. Depending on that relationship, compactive effort can be increased to provide the proper soil stiffness or decreased for economical reasons to provide the predetermined reference soil stiffness.

Having described the physics and mechanics involved, we will now describe practical applications of the same. In a first embodiment, a system and a device 10 are provided for controlling and delivering compactive effort of a compaction unit and for predicting the suitability or acceptability of a soil being compacted. According to one embodiment, the device and system 10 can do so continuously, in real-time, and in a non-destructive, non-intrusive manner.

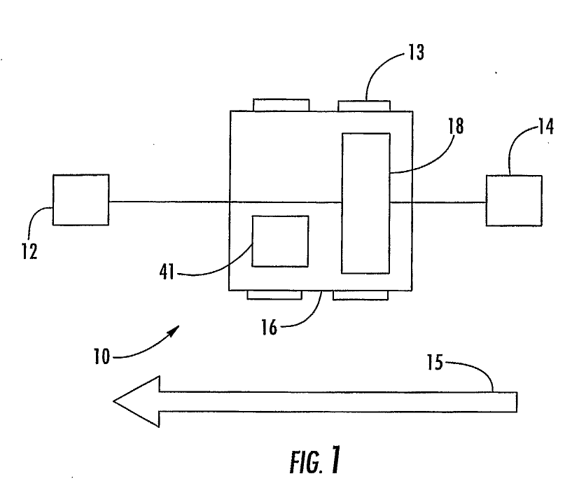

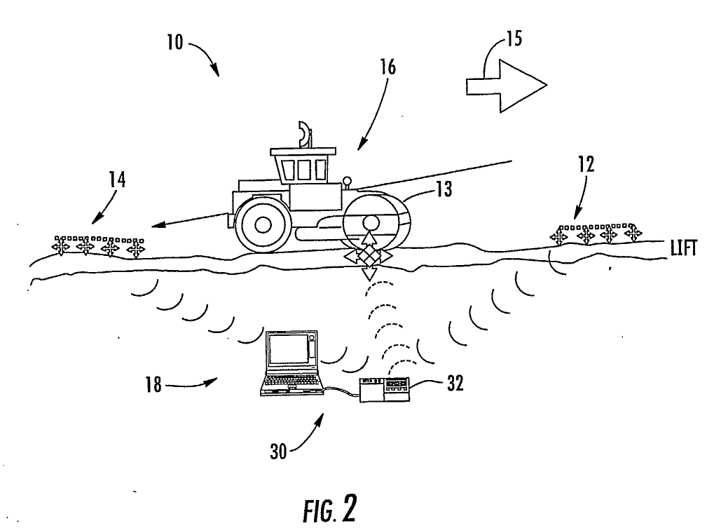

According to the embodiments shown in FIGS. 1 and 2, the system and apparatus 10 comprise a first sensing unit 12, a second sensing unit 14, a prime mover 16, and a control unit 18. The first sensing unit 12 is disposed in front of the prime mover 16 in its direction of movement (arrow 15) and the second sensing unit 14 is disposed behind the prime mover 16 in the direction of movement (arrow 15). The control unit 18 can be structured and arranged on the prime mover 16. In an alternative embodiment, the control unit 18 can be structured and arranged to control the prime mover 16 remotely.

In one embodiment, the first and second sensing units 12 and 14 comprise an array of sensors. In a particular embodiment, the first and second sensing units 12 and 14 comprise an array of accelerometers, which are capable of acquiring waveform information (e.g., time of travel of the waveform, direction of motion, amplitude, and the like) from the vibration waves produced by the compaction unit 13. In a further embodiment, the accelerometers are tri-axial accelerometers that are capable of collecting data that includes, without limitation, the time of arrival of the waves (e.g., shear (S) wave, Raleigh wave, and P wave), the various components of the waveform, and the amplitude of each component.

Optionally, the accelerometers can also provide means to doubly-integrate the measured accelerations to provide an estimation of the displacement (e.g., using FFT techniques) and means for transmitting data to and receiving data from the control unit 18. Alternatively, the accelerometers can simply measure the acceleration of the waves and transmit the acceleration data to the control unit 18 or another remote device, in which case, the control unit 18 or the other remote device, would include means to doubly-integrate the measured accelerations (e.g., using FFT techniques) to provide an estimation of the displacement.

According to various embodiments, each accelerometer sensor is a tri-axial-type device to measure acceleration of the P-wave, the S-wave, and the Raleigh wave. In one embodiment, the sensors provide analog wireless or hardwire signals. In another embodiment, the sensors provide digital wireless signals or include an A/D converter to convert analog signals to digital signals prior to wireless transmission. Such devices are readily available from, for example, Endevco Corporation of San Juan Capistrano, California, Entran Devices, Inc. of Fairfield, N.J., Omega Engineering, Inc. of Stamford, Conn., and the like.

For example, each sensing unit 12 and 14 can include a plurality of (e.g., four) tri-axial accelerometers that are structured and arranged in a pattern (e.g., a straight line, a diagonal line, a diamond shape and the like) at a predetermined distance apart. In one embodiment, the accelerometers can be aligned with the direction of travel 15 of the primer mover 16 so that the centerline of the sensor array is co-linear or substantially co-linear to the centerline of the prime mover 16. In a farther embodiment, each accelerometer can send acceleration data to a data acquisition device 30 (e.g., a data acquisition computer (“DAC”) using a wireless communication protocol) such as Bluetooth, Wi-Fi, or similar low-frequency radios that are immune to electrical noise common to a construction site). In a particular embodiment, the DAC 30 can receive analog data signals from all sensing units 12 and 14 in real time, process the data, and farther relay this data in a human readable format (e.g., to a visual display) if the prime mover 16 is manually operated or in a machine readable format (e.g., to the electronic control system 18) if the prime mover 16 is automatically controlled.

In various embodiments, the first and second sensing units 12 and 14 can be structured and arranged on mobile units (not shown) (e.g., all-terrain vehicles, or “ATVs”, that are operated in front of and behind a moving prime mover 16). In one embodiment, the mobile units can be operated manually (e.g., driven by an operator), or in an alternative embodiment can be operated remotely (e.g., using infrared distance measuring equipment and the like that is disposed on the mobile unit). In yet another embodiment, the sensing unit 12 and 14 can be powered using a power source associated with the operation of the ATV (e.g., the ATV's battery or with a separate power source that is disposed on the ATV for that purpose).

In yet another embodiment, the first and second sensing units 12 and 14 can be suspended (e.g., from booms (not shown) emanating from the prime mover 16). In addition, the sensing units 12 and 14 can be powered using a power source associated with the operation of the prime mover 16 (e.g., the prime mover's battery), or with a separate power source 41 that is disposed on the ATV for that purpose. When the first and second sensing units 12 and 14 are suspended, a communication link between the accelerometers and a DAC 30 disposed on the prime mover 16 is possible using a hardwire communication link (e.g., a cable, wire and the like) or a wireless communication link.

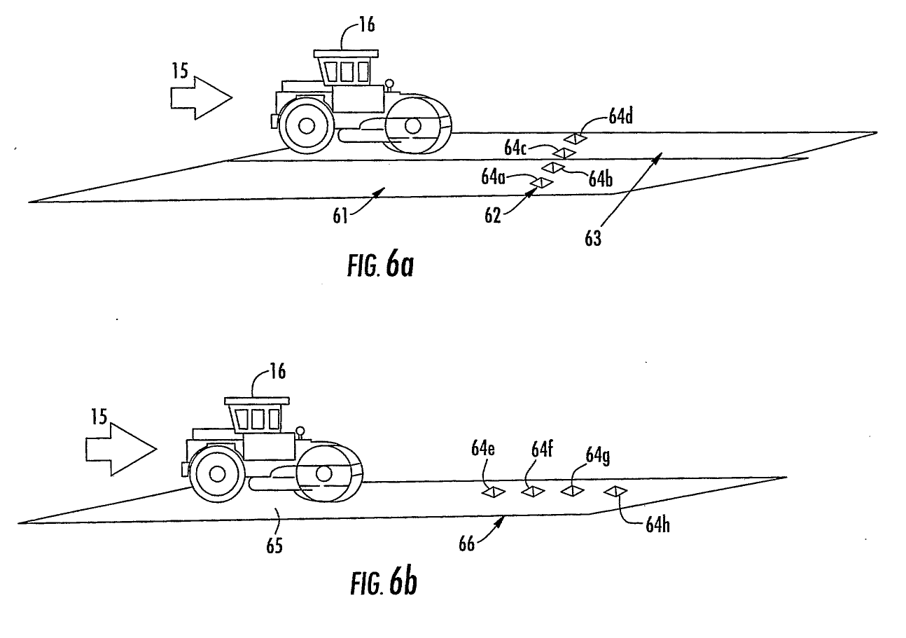

Alternatively, according to one embodiment, the first and second sensing units 12 and 14 can be pre-positioned at one or more stationary locations forward and aft of the prime mover, and subsequently re-positioned periodically. FIGS. 6A and 6B show two embodiments of dismounted accelerometer 64 layouts. FIG. 6A shows a perpendicular arrangement 62 of accelerometers 64 in which the accelerometers 64 are positioned on the area to be compacted perpendicular to the direction of travel 15 of the prime mover 16. When the accelerometers 64 are disposed perpendicularly or substantially perpendicularly to the direction of travel 15 of the prime mover 16, it is possible to acquire data on spatial variability as a function of compactive effort according to various embodiments of the invention. For example, accelerometers 64a and 64b can be positioned in one strip 61 and subjected to compactive efforts involving five passes of the prime mover 16 while accelerometers 64c and 64d can be positioned in an adjacent strip 63 and subjected to compactive efforts involving two passes of the prime mover 16. Accordingly, information on the degree of compaction as a function of the number of passes as well as the relative compactive effort of adjacent strips 61 and 63 can be provided.

FIG. 6B show an in-line arrangement 66 of accelerometers 64 in which the accelerometers 64 are positioned on the area to be compacted along the centerline of the direction of travel 15 of the prime mover 16. According to various embodiments, this placement of accelerometers 64 can be used, for example, to evaluate multiple depths of influence and concomitant compactive effort. More specifically, accelerometers 64e through 64h can be structured and arranged to provide measurements for increasingly deeper depths of compaction. Accordingly, information on the degree of compaction with depth can be provided.

Although four accelerometers 64 are shown in FIGS. 6A and 6B, the invention is not to be construed as being so limited. Indeed, any number and any arrangement of accelerometers 64 can be used without violating the scope and spirit of this disclosure.

In various embodiments, power can be provided to each of the dismounted accelerometers 64 using a power cable (not shown) emanating from a power source (e.g., a battery pack (not shown)) that can be located either on or near the persons responsible for moving the units.

In addition, according to various embodiments, the prime mover 16 is a traction-type vehicle (e.g., an all-terrain vehicle, a tractor, and the like) that provides a mobile platform that can move, or travel, along a desired azimuth at a desired rate of speed for a desired distance. The prime mover 16 can be structured and arranged to provide a stable platform for the aforementioned sensing units 12 and 14 and the control unit 18 described hereinafter.

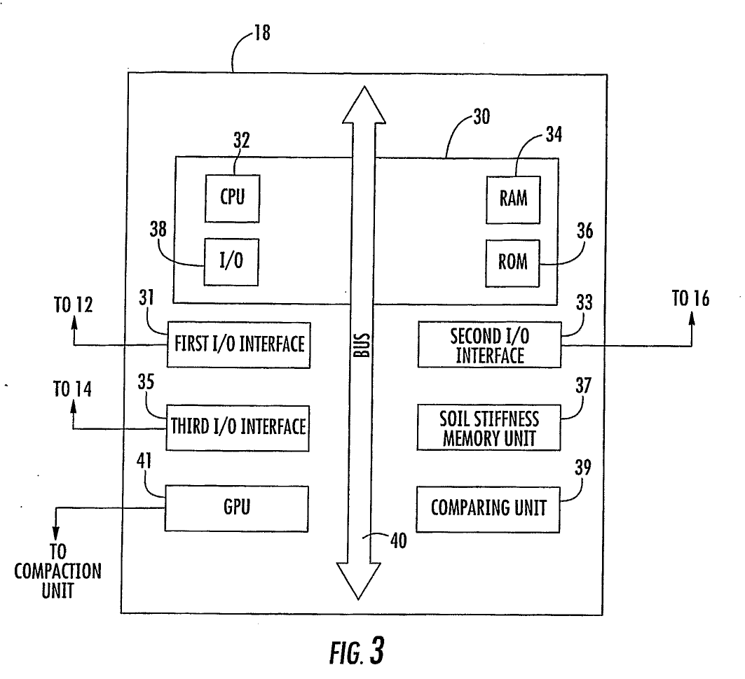

According to the embodiment shown in FIG. 3, the control unit 18 comprises a microprocessor 30 that has a central processing unit 32, random access memory (RAM) 34 for executing one or more applications, read-only memory (ROM) 36 for storing a plurality of executable applications, and an input/output (“I/O”) device 38. The control unit 18 further includes a first input/output interface 31 for receiving data signals from and transmitting signals to the remote sensing units 12 and 14, a second input/output interface 33 for receiving signals from and transmitting signals to the prime mover 16, a third input/output interface 35 for receiving signals from and communicating signals to the compaction unit 13, a soil stiffness memory unit 37 for storing a predetermined reference stiffness value and soil displacement data and position data from the sensing units 12 and 14, a comparing unit 39 for comparing displacement data at a discrete global position from the first sensing unit 12 with displacement data at the same global position from the second sensing unit 14, a global positioning unit 41 for providing global position data for tagging displacement data from the sensing units 12 and 14, and a bus line 40 for communicating data and signals between elements of the control unit 18.

The microprocessor 30 can be a personal computer (“PC”) (e.g., a portable or mountable PC) that can control the device or system 10 to provide data and corrections to the compaction unit to provide the desired soil stiffness. In one embodiment, the microprocessor 30 is mounted on the prime mover 16 and structured and arranged to be in communication with the first and second sensing units 12 and 14 (e.g., wirelessly or by hardwire). Alternatively, the microprocessor 30 can be disposed remotely, communicating with the device and system 10 wirelessly by LAN, WAN, low frequency transmission (e.g., wireless fidelity or Wi-Fi), the Internet, and the like. In a further embodiment, the microprocessor 30 can include RAM 34 for temporarily storing an application to be executed by the CPU 32, ROM 36 for storing one or more applications (e.g., software algorithms) that determine what compaction or driving corrections to make, and the like. The I/O device 38 enables a user to access the device or system 10 for any purpose.

According to one embodiment, global positioning unit 41 provides global position data for the prime mover 16 and for each displacement datum from the first and second sensing units 12 and 14. The global positioning unit 41 communicates with each of the sensors (e.g., accelerometers) so that each data reading from that sensor can be tagged with its corresponding global position. In one embodiment, the global positioning unit 41 is a differential global positioning unit 41, which, by using a known reference point, can provide a more accurate position (e.g., within a few centimeters).

The first input/output interface 31 is structured and arranged to receive data signals from and transmit signals to the remote sensing units 12 and 14 and receive position data from the global positioning unit 41. In one embodiment, the data signals from remote sensing units 12 and 14 and data signals from the global positioning unit 41 are analog signals that are first converted from analog to digital (e.g., using an analog/digital (“A/D”) converter, which is not shown). In a further embodiment, each data (e.g., displacement) signal is flagged with its global position and stored in the stiffness memory 37. Flagging each data signal with its corresponding global position datum makes it possible to compare before and after displacement data at the same or substantially the same global position according to various embodiments.

The second input/output interface 33 is structured and arranged to receive data from and transmit data to the prime mover 16 for controlling the rate and direction of travel of the prime mover 16. In one embodiment, the second input/output interface 33 receives current driving condition data (e.g., speed, azimuth, and the like) from the prime mover 16, which it transmits to the microprocessor 30. The microprocessor 30 uses these data in combination with global position data from the global positioning unit 41 to make changes in the driving condition data (e.g., accelerate, decelerate, turn to the left, turn to the right, and the like). These new driving condition data are communicated to the prime mover 16 via the second input/output interface 33 and changes to the driving conditions are made accordingly.

The third input/output interface 35 is structured and arranged to receive data from and transmit data to the compaction unit 13 to control the rate and direction of travel of the compaction unit 13 and adjust the compacting effort being delivered to the soil by the compaction unit 13. In one embodiment, the third input/output interface 35 receives current compaction condition data (e.g., speed, azimuth, compactive effort) from the compaction unit 13 which it transmits to the microprocessor 30. The microprocessor 30 uses these data in combination with soil stiffness data to make changes in the compaction condition data (e.g., accelerate, decelerate, increase compactive effort, decrease compactive effort, and the like). These new compaction condition data are then communicated to the compaction unit 13 via the third input/output interface 35 and changes to the compaction conditions are made accordingly.

According to various embodiments, the soil stiffness memory unit 37 includes one or more memories for storing a predetermined reference stiffness value, displacement and global position data from the first sensing unit 12, and displacement and global position data from the second sensing unit 14. These data can be stored in one or more memories temporarily to be erased after their use or, alternatively, these data can be stored permanently to create a historical record of the same. In a particular embodiment, the soil stiffness memory unit 37 is pre-programmed with a predetermined reference stiffness value, which corresponds to the soil stiffness desired by the engineers or scientists. Furthermore, the soil stiffness memory unit 37 receives and stores displacement data and global position data from the first sensing unit 12 in a first memory area and displacement data and global position data from the second sensing unit 14 in a second memory area. Data are stored in the first and second memory areas according to the global positioning data. When the first and second memory areas, respectively, have displacement data from the first and second sensing units 12 and 14 for the same or substantially the same global position, the soil stiffness memory unit 37 communicates these data to the comparing unit 39.

In various embodiments, the comparing unit 39 compares displacement data from the first and second sensing units 12 and 14 for the same or substantially the same global position to estimate the relative soil stiffness and, hence, indirectly, the effectiveness of the compaction conditions. If soil stiffness is the same or substantially the same as the predetermined stiffness value, then the compaction conditions are acceptable. If, however, the soil stiffness is not the same as the predetermined stiffness value, then the comparing unit 39 communicates these data to the microprocessor 30, which provides changes to the present compaction condition (e.g., increase compactive effort, decrease compactive effort, and the like) consistent with providing a soil stiffness within tolerable limits.

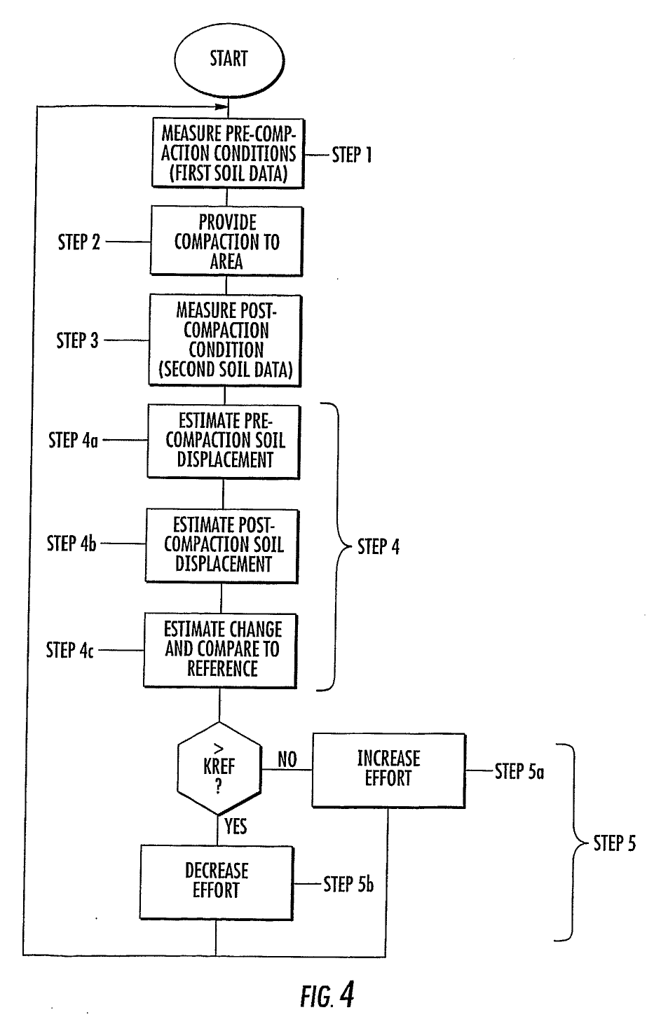

Having described various embodiments of devices and systems for controlling the compactive effort of a compaction unit to predict the stiffness of a soil being compacted and/or to control the compactive effort applied to the soil, we will now describe a method for controlling the compactive effort of a compacting unit and, relatedly, for controlling the stiffness of a soil according to various embodiments according to various other embodiments of the invention. FIG. 4 provides a flow chart of a method of controlling the compactive effort of a compaction unit according to one embodiment. In a first step, the method comprises measuring first soil data (e.g., time of arrival of a shear wave, time of arrival of a Raleigh wave, time of arrival of a P-wave, components of the waveform in three orthogonal directions, and/or amplitude of each component of the waveform, and the like) at a plurality of discrete locations over an area (STEP 1). In a particular embodiment, the step of measuring first soil data comprises the sub-steps of measuring the acceleration of a vibration-induced waveform passing through each of the plurality of discrete locations (e.g., using an accelerometer and a tri-axial accelerometer) and integrating the acceleration of the waveform passing through each of the plurality of discrete locations twice (e.g., using FFT techniques) to estimate the displacement of the soil prior to compaction.

In a second step, the method comprises providing or delivering a compactive effort to the soil in the area of the plurality of discrete locations (STEP 2). Typically, the compactive effort is provided using mechanical, impact-type compaction units (e.g., a sheep's-foot roller or a rubber-tired roller) or using vibratory-type compaction units (e.g., a vibratory-drum roller).

Subsequent to compacting the in situ soil, the method includes the step of measuring second soil data (e.g., time of arrival of a shear wave, time of arrival of a Raleigh wave, time of arrival of a P-wave, components of the waveform in three orthogonal directions, and/or amplitude of each component of the waveform, and the like) at the same plurality of discrete locations (STEP 3). In one embodiment, the step of measuring second soil data comprises the sub-steps of measuring the acceleration of a vibration-induced waveform passing through each of the plurality of discrete locations (e.g., using an accelerometer and a tri-axial accelerometer) and integrating the acceleration of the waveform passing through each of the plurality of discrete locations twice (e.g., using FFT techniques) to estimate the displacement of the soil prior to compaction.

The next step includes comparing first soil data and second soil data with a predetermined reference value (STEP 4). In one embodiment, this can involve estimating the displacement of the soil before compaction (STEP 4a) and estimating the displacement of the soil at the same global position after compaction (STEP 4b). In a particular embodiment, the sub-steps of estimating displacement of the soil includes integrating the acceleration curve of the waveform passing through each of the plurality of discrete locations twice to estimate the displacement of the soil. The difference, or change in displacement, can then be compared with the predetermined reference value (STEP 4c). In a further embodiment, the step of estimating a change in a displacement of the soil before and after compaction and comparing the change in displacement with the predetermined reference value includes comparing the change in displacement with a predetermined reference value relating to soil stiffness (STEP 4).

Finally, the method includes the step of modifying the compactive effort provided or delivered (STEP 5) to the soil based on results from the comparison step. For example, if the change in displacement is less than the predetermined reference value, then compactive effort can be increased (STEP 5a). In one embodiment, the sub-step of increasing the compactive effort comprises decreasing a rate of advance of the compacting unit, increasing the vibration level (i.e., amplitude) of a vibratory compactor, modulating the frequency of the energy source, altering the direction of force (from vertical to horizontal), and the like. Similarly, if the change in displacement is greater than the predetermined reference value, then compactive effort can be decreased (STEP 5b). In one embodiment, the sub-step of decreasing the compactive effort comprises increasing a rate of advance of the compacting unit, decreasing the vibration level of a vibratory compactor, modulating the frequency of the energy source, altering the direction of force (from vertical to horizontal), and the like.

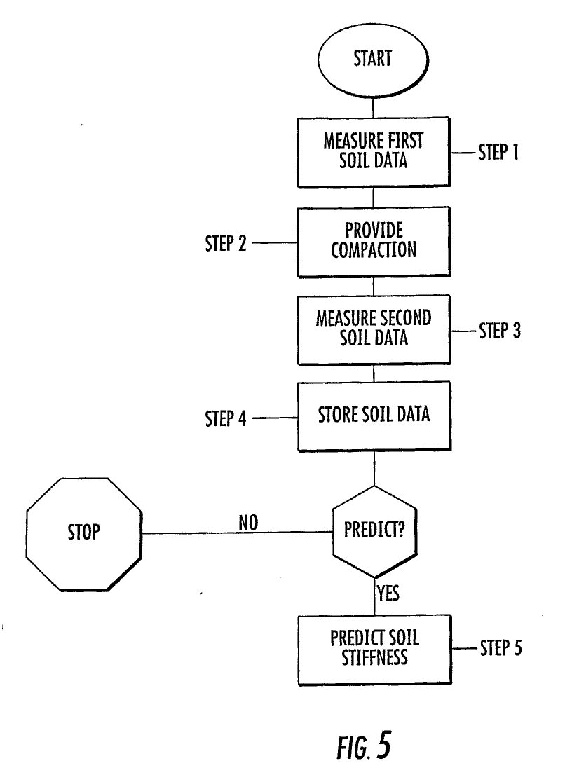

Having described a method of controlling the compactive effort of a compaction unit according to various embodiments, we will now describe methods for continuously monitoring soil stiffness during compaction according to other embodiments of the invention. In particular, FIG. 5 shows a flow chart of an exemplary method for continuously monitoring soil stiffness during compaction according to various embodiments of the invention. As was the case with the method of controlling compactive effort, in a first step, the method comprises measuring first soil data at a plurality of discrete locations over an area (STEP 1). In one embodiment, the step of measuring first soil data comprises the sub-steps of measuring the acceleration of a waveform passing through each of the plurality of discrete locations (e.g., using an accelerometer) and integrating the acceleration of the waveform passing through each of the plurality of discrete locations twice (e.g., using FFT techniques) to estimate the displacement of the soil prior to compaction.

In a second step, the method comprises providing a compactive effort to the area of the plurality of discrete locations (STEP 2). Typically, according to various embodiments, the compactive effort is provided using mechanical, impact-type compaction units (e.g., a sheep's-foot roller or a rubber-tired roller) or using vibratory-type compaction units (e.g., a vibratory-drum roller).

Subsequent to compacting the in situ soil, the method includes measuring second soil data at the same plurality of discrete locations (STEP 3). In one embodiment, the step of measuring second soil data again comprises measuring the acceleration of a waveform passing through each of the plurality of discrete locations (e.g., using an accelerometer) and integrating the acceleration of the waveform passing through each of the plurality of discrete locations twice to estimate the displacement of the soil.

The next step includes recording (e.g., storing) the measurement data from STEPS 1 and 3 (STEP 4). Measurement data can be stored in any memory provided for that purpose, including, without limitation the soil stiffness memory unit and the RAM of the control unit.

Having described various embodiments of methods of controlling the compactive effort of a compaction unit and for continuously monitoring soil stiffness during compaction, we will now describe a method for predicting the stiffness of a soil being compacted according to various embodiments of the invention. In particular, FIG. 5 shows a flow chart of a method for predicting the stiffness of a soil being compacted of for continuously monitoring soil stiffness during compaction according to various embodiments. STEPs 1-4 are identical to the description immediately above for a method of continuously monitoring soil stiffness during compaction. In a fifth step, after the first and second soil data are recorded (e.g., in a non-volatile memory) to provide a historical record thereof and the first and second soil data are compared with a predetermined reference value (e.g., a soil stiffness value) to predict the stiffness of the compacted soil (STEP 5).

In another embodiment, a program embodied in a computer-readable medium (e.g., a software program or algorithm) is provided for controlling the compactive effort delivered to a soil by a compaction unit. In one embodiment, the program comprises computer executable instructions (e.g., source code) for measuring first soil data at a plurality of discrete locations over an area, computer executable instructions for instructing the compaction unit to deliver a compactive effort to the area of the plurality of discrete locations, and computer executable instructions for measuring second soil data at said plurality of discrete locations. Additionally, the program can include computer executable instructions for comparing first soil data and second soil data with a predetermined reference value.

In yet another embodiment, a program embodied in a computer-readable medium (e.g., a software program or algorithm) is provided for controlling a compactive effort delivered to a soil by a compaction unit. In one embodiment, the program comprises computer executable instructions (e.g., source code) for measuring first soil data at a plurality of discrete locations over an area, computer executable instructions for providing a compactive effort to the area of the plurality of discrete locations, computer executable instructions for measuring second soil data at said plurality of discrete locations, computer executable instructions for comparing first soil data and second soil data with a predetermined reference value, and computer executable instructions for modifying the compactive effort delivered to the soil based on results from the comparison step.

Various embodiments of the invention have been described in detail, including preferred embodiments thereof However, modifications and improvements within the scope of this invention will occur to those skilled in the art. The above description is intended to be exemplary only. The scope of this invention is defined only by the following claims and their equivalents.

1. A soil compacting device comprising:
a compaction unit adapted for delivering a compactive effort to a soil, the compaction unit being movable in a desired direction of travel;
a first sensing unit that is adapted to measure first sensing data at a discrete global position at a first point in time, the discrete global position being in front of the compaction unit in the direction of travel at the first point in time;
a second sensing unit that is adapted to measure second sensing data at the discrete global position at a second point in time that is later than the first point in time, the discrete global position being behind the compaction unit in the direction of travel at the second point in time;
a comparing unit that is adapted to compare the first sensing data and the second sensing data; and
a control unit that is adapted to modify the compactive effort delivered to the soil by the compaction unit based on the comparison between the first sensing data and the second sensing data.

2. The soil compacting device of claim 1, wherein the comparing unit is further adapted to determine a difference between the first sensing data and the second sensing data.

3. The soil compacting device of claim 2, wherein the difference between the first sensing data and the second sensing data comprises an estimation of the difference between the first sensing data and the second sensing data.

4. The soil compacting device of claim 2, wherein the difference between the first sensing data and the second sensing data comprises the results of a discrete calculation of the difference between the first sensing data and the second sensing data.

5. The soil compacting device of claim 1, wherein the first sensing unit and the second sensing unit comprise one or more sensors.

6. The soil compacting device of claim 5, wherein each of the one or more sensors comprises an accelerometer adapted for measuring and recording waveform data.

7. The soil compacting device of claim 5, wherein each of the one or more sensors comprises a tri-axial accelerometer, the tri-axial accelerometer being adapted for measuring and recording a time of arrival of a wave, said wave being selected from the group consisting of: a shear wave, a Raleigh wave, and a P wave.

8-12. (canceled)

13. The soil compacting device of claim 2, wherein the difference between the first sensing data and the second sensing data comprises a change in displacement caused by the compactive effort.

14. The soil compacting device of claim 2, wherein the control unit is adapted to increase the compactive effort of the compaction unit in response to the comparing unit determining that the difference between the first sensing data and the second sensing data is less than a predetermined reference value.

15. The soil compacting device of claim 14, wherein the control unit is adapted to increase the compactive effort by decreasing a rate of advance of the compaction unit.

16. The soil compacting device of claim 2, wherein the control unit is adapted to decrease the compactive effort of the compaction unit in response to the comparing unit determining that the difference between the first sensing data and the second sensing data is greater than a predetermined reference value.

17. The soil compacting device of claim 16, wherein the control unit is adapted to decrease the compactive effort by increasing a rate of advance of the compaction unit.

18. The soil compacting device of claim 1, wherein the device further comprises a global positioning unit adapted for associating one or more discrete global position coordinates with the first sensing data and second sensing data, the one or more discrete global position coordinates identifying the discrete global position.

19. A method for controlling a compactive effort delivered to a soil by a compaction unit, the method comprising the steps of:
measuring first soil data at a plurality of discrete locations over an area;
providing a compactive effort to said area;
measuring second soil data at said plurality of discrete locations;
determining a difference between the first soil data and the second soil data,
comparing said difference with a predetermined reference value; and
modifying the compactive effort delivered to the soil by the compaction unit based on results from the step of comparing the difference with the predetermined reference value.

20. The method as recited in claim 19, wherein the steps of measuring the first soil data and the second soil data comprise measuring the time of arrival of a wave at each of the plurality of discrete locations, the wave selected from the group consisting of: a shear wave, a Raleigh wave, and a P wave.

21. The method as recited in claim 19, wherein the steps of measuring the first soil data and the second soil data comprise measuring an acceleration of a vibration wave in three orthogonal directions at each of the plurality of discrete locations.

22. The method as recited in claim 21, wherein the steps of measuring the first soil data and the second soil data further comprise integrating the acceleration of the vibration wave passing through each of the plurality of discrete locations twice to estimate a displacement of the soil.

23. The method as recited in claim 19, wherein the steps of measuring the first soil data and the second soil data comprise measuring an amplitude of the acceleration of the vibration wave in each of the three orthogonal directions at each of the plurality of discrete locations.

24. The method as recited in claim 19, wherein the step of comparing the difference between the first soil data and the second soil data with the predetermined reference value comprises estimating a change in a displacement of the soil before and after the step of providing the compactive effort and comparing the change in displacement with the predetermined reference value.

25. The method as recited in claim 24, wherein the predetermined reference value relates to soil stiffness, and wherein the step of estimating the change in displacement of the soil comprises comparing the change in displacement with the predetermined reference value.

26. The method as recited in claim 19, wherein the step of modifying the compactive effort delivered to the soil comprises increasing the compactive effort in response to determining that the difference between the first soil data and the second soil data is less than the predetermined reference value.

27. The method as recited in claim 26, wherein the step of increasing the compactive effort comprises one or more steps selected from the group consisting of: decreasing a rate of advance of the compaction unit, increasing a vibration level, modulating a frequency of an energy source, and altering a direction of force.

28-31. (canceled)

32. The method as recited in claim 19, wherein the step of modifying the compactive effort delivered to the soil comprises decreasing the compactive effort in response to determining that the difference between the first soil data and the second soil data is greater than the predetermined reference value.

33. The method as recited in claim 32, wherein the step of decreasing the compactive effort comprises one or more steps selected from the group consisting of: increasing a rate of advance of the compaction unit, decreasing a vibration level, modulating a frequency of an energy source, and altering a direction of force.

34-37. (canceled)

38. A soil compacting device comprising:
a compaction unit adapted for delivering a compactive effort to a soil, the compaction unit being moveable in a desired direction of travel;
a first sensing unit that is adapted to measure first sensing data at a discrete global position at a first point in time, the discrete global position being in front of the compaction unit in the direction of travel at the first point in time;
a second sensing unit that is adapted to measure second sensing data at the discrete global position at a second point in time that is later than the first point in time, the discrete global position being behind the compaction unit in the direction of travel at the second point in time;
a comparing unit adapted to determine a difference between the first and the second sensing data and compare the difference with a predetermined reference value; and
a control unit adapted to modify the compactive effort delivered to the soil by the compaction unit based on the comparison of the difference between the first sensing data and the second sensing data and the predetermined reference value.

39. The system as recited in claim 38, wherein the difference between the first sensing data and the second sensing data comprises a change in displacement.

40. The system as recited in claim 38, wherein the control unit is adapted to increase the compactive effort of the compaction unit in response to the comparing unit determining that the difference between the first sensing data and the second sensing data is less than the predetermined reference value.

41. The system as recited by claim 40, wherein the control unit is adapted to increase the compactive effort by decreasing a rate of advance of the compaction unit.

42. The system as recited in claim 38, wherein the control unit is adapted to decrease the compactive effort of the compaction unit in response to the comparing unit determining that the difference between the first sensing data and the second sensing data is greater than the predetermined reference value.

43. The system as recited by claim 42, wherein the control unit is adapted to decrease the compactive effort by increasing a rate of advance of the compaction unit.

44-69. (canceled)
